(19) United States
(12) Patent Application Publication
(10) Pub. No.: US 2022/0227525 A1
(43) Pub. Date: Jul. 21, 2022

(54) Basket Made from Recycled Cardboard or Paperboard Material

(71) Applicants: 2Move Consulting Assessoria Em Negócios Comerciais Ltda, Sao Paulo (BR); Inesperado Idéias, Projetos E Negócios Ltda, Säo Paolo (BR)

(72) Inventors: André Luís Ferreira Souza, São Paulo (BR); Marcus Vinícius Monteiro Santarém, São Paulo (BR)

(21) Appl. No.: 17/716,143

(22) Filed: Apr. 8, 2022

Related U.S. Application Data
(63) Continuation-in-part of application No. PCT/BR2021/050189, filed on May 5, 2021.

(30) Foreign Application Priority Data
May 14, 2020 (BR) 202020009686-4

(51) Int. Cl. B65D 5/20; B65D 5/42; B65D 5/478; B65D 5/46

(52) U.S. Cl. CPC B65D 5/20; B65D 5/4266; B65D 5/4212; B65D 5/4612; B65D 5/46056

(57) ABSTRACT

A basket of recycled cardboard or paperboard material, for carrying goods/products and belongings, the basket being made with different layers and weight and having different dimensions of length×width×height, with 50×30×10 cm, 30×20×10 cm and 40×25×18 cm being the three preferred ones, the basket having handles (2.1), lines/creases (4), cuts/slits (5, 5.1 and 5.2), folds (6) and fittings (7) to give it the final shape and reinforce the resistance to perform its functions, the basket having handles made of 5 mm kraft twisted cord (2) or the basket material itself (2.1) and spaces (3) reserved for advertising products and brands.

### BACKGROUND OF THE INVENTION

The present utility model patent refers to baskets of recycled material made of cardboard or paperboard for use in commercial stores, replacing plastic baskets, with the purpose of serving for the disposal and transport of goods/products and belongings, during the staying of users in said places. In other words, the patent consists of offering to the market an ecological basket or tray, unprecedented and completely sustainable. It belongs to the technical sector of packaging made of recycled cardboard or paperboard.

Currently, almost all commercial establishments choose to use plastic baskets (high-density polyethylene), of different models, shapes and dimensions, to meet the aforementioned purpose, with the justification of their long shelf life.

In chemistry and technology, plastics are synthetic polymeric organic materials, with a macromolecular constitution, endowed with great malleability (which have the property of adapting to different shapes), easily transformable through the use of heat and pressure, and which serve as raw material for the manufacture of the most varied objects.

In the conventional plastic manufacturing process, in turn, oil is transformed into resin, which goes through different processes until reaching the desired formation.

Plastic baskets have expensive environmental costs: for its production, oil or natural gas (both non-renewable natural resources), water and energy are consumed, and effluents (liquid waste) and toxic and greenhouse gas emissions are released.

Historically, more than 8 million tons of plastic waste ends up in the oceans every year, with an estimated decomposition time of around 400 years.

Although there are already initiatives to develop plastic materials based on plants and ethylene from sugarcane, the baskets available in commercial establishments are predominantly made of synthetic polymeric organic materials and do not cope sustainable requirements, promoting harmful effects both in production and in disposal, whose processes, when respected, are more complex and costly, when compared to paper ones.

### SUMMARY OF THE INVENTION

To solve these problems, the sustainable basket made of cardboard or recycled cardboard, object of the present utility model patent, was designed.

Paper consists of a biodegradable material, produced from a sustainable source, cellulose from wood, and resulting from an intensive process that consumes another natural resource, water. Therefore, its production involves the use of renewable resources and with impacts to the environment much lower than that of plastic, both at the origin and in the disposal, being its decomposition time of 03 to 06 months. When we talk about recycled paper, which consists of the raw material of the basket, object of the present patent, the advantages become even greater.

After carrying out a general assessment of the two types of paper, the result was R$241/ton, equivalent to a 35% reduction in relation to the R$687/ton in the cost of producing common paper. Regardless of the commercial gain, which is not the main object of the comparison, paper recycling can also be a great environmental benefit, as for every 28 ton of recycled paper, 1 ha of forest is avoided. While, to manufacture a ton of common paper, around 60 eucalyptus trees are used, 100,000 l of water and 5,000 KW/h of energy are used, for paper recycling it is necessary 1,200 kg of old paper, 2,000 l of water and 1000 to 2500 KW/h (ABREPRO, 2013). Another relevant factor of recycled paper is the reduction in 74% of pollutants released into the air and in 35% of those dumped in the water, in addition to avoiding the emission of 2.5 ton of CO2 into the atmosphere in the recycling of one ton of newspapers (ABEPRO, 2013).

Another important advantage of paper recycling is the reduction of solid waste. Corresponding on average to 25% of the composition of urban solid waste, paper recycling allows the release of space in landfills for other non-recyclable materials and products. In terms of waste produced, the sludge resulting from effluents can, in some cases, be used as fertilizer for agriculture. Based on the description of each process presented above, the preference for recycled cardboard/paperboard over others is based on economic and fundamentally environmental reasons, which are highlighted below.

Recycled cardboard and paperboard are 100% free of petrochemicals and toxic additives;

Recycled cardboard and paperboard are recyclable, recoverable and biodegradable;

Cardboard/paperboard packages are light, resistant, hygienic and economical, constituting an effective protective barrier against contaminants;

The use of recycled cardboard/paperboard saves natural resources, such as water, energy and cellulose, reduces the emission of pollutants released into the air and/or dumped into the water, in addition to reducing CO2 emissions into the atmosphere and the accumulation of solid waste in landfills;

The environmental impact resulting from the manufacture of paper, although smaller than that of plastic, has been decreasing more and more, either by the reduction of energy and water consumption or by the development of new technological processes, or even by the increasing use of recycled fibers in the new paper making;

Paper can be recycled up to 7 times, thus avoiding excessive planting and cutting of trees for its production, and automatically the acquisition of new raw material, thus favoring the environment and forming a reverse chain;

Cardboard/paperboard that can no longer be recycled can still be used for energy, through its transformation into fuel;

Despite having been designed for the B-B segment, there is still the possibility for consumers to purchase sustainable baskets for their own use. If this trend is confirmed, there will be a positive side effect, in terms or reducing the use of plastic bags for storing goods after purchases.

The drawings that accompany and form part of this report represent the basket of recycled material made of cardboard or cardboard, which may have different weights and weights, whose dimensions will be defined according to the levels of effort to which they will be submitted.

### BRIEF DESCRIPTION OF THE DRAWINGS

FIG. 1 is a plan view of a blank for forming the basket according to the present invention, with internal dimensions 50×30×10 cm;

FIG. 2 is a plan view of a blank for forming the basket according to the present invention, with internal dimensions 30×20×10 cm;

FIG. 3 is a plan view of a blank for forming the basket according to the present invention, with internal dimensions 40×25×18 cm;

FIG. 4 is a perspective view of a basket which is fully assembled from the blank of FIG. 2, with corner spaces for advertisements;

FIG. 5 is a perspective view of a basket which is fully assembled from the blank of FIG. 2, with a central space for an advertisement;

FIG. 6 is a perspective view of a basket which is fully assembled from the blank of FIG. 2, with a central space along a longer wall for an advertisement;

FIG. 7 is a plan view of a blank for forming the basket according to the present invention, with internal dimensions 30×20×10 cm, similar to FIG. 2, but with handles formed from the blank material;

FIG. 8 is a perspective view of the blank of FIG. 7 after a first assembling step;

FIG. 9 is a perspective view of the blank of FIG. 7 after a second assembling step;

FIG. 10 is a perspective view of the blank of FIG. 7 after a third assembling step; and

FIG. 11 is a perspective view of the blank of FIG. 7 in a fully assembled condition.

### DETAILED DESCRIPTION

The basket (1) can have different dimensions of length×width×height, these three being the preferred ones: 50×30×10 cm, 30×20×10 cm and 40×25×18 cm.

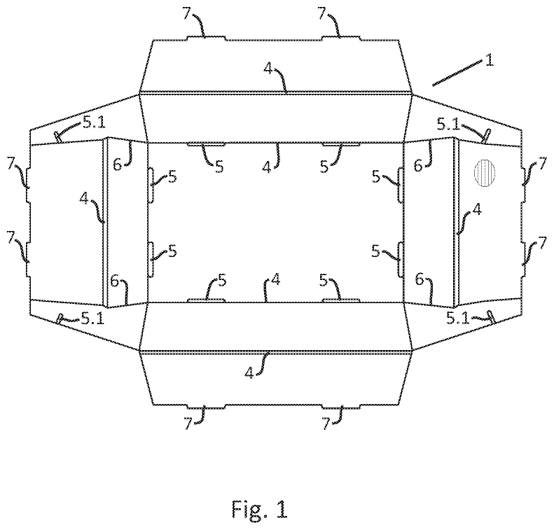

FIG. 1 is an external view of the technical plan of the basket (1) with internal dimensions 50×30×10 cm before assembly, showing its constructive details: lines/creases (4), cuts/slits (5 and 5.1), folds (6) and fittings (7) that give it its final shape and reinforce its resistance.

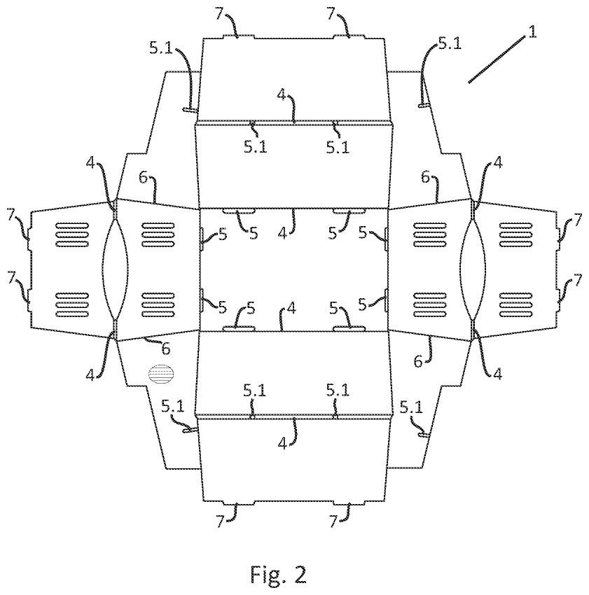

FIG. 2 is an external view of the technical plan of the basket (1) with internal dimensions 30×20×10 cm before assembly, showing its constructive details: lines/creases (4), cuts/slits (5 and 5.1), folds (6) and fittings (7) that give it its final shape and reinforce its resistance.

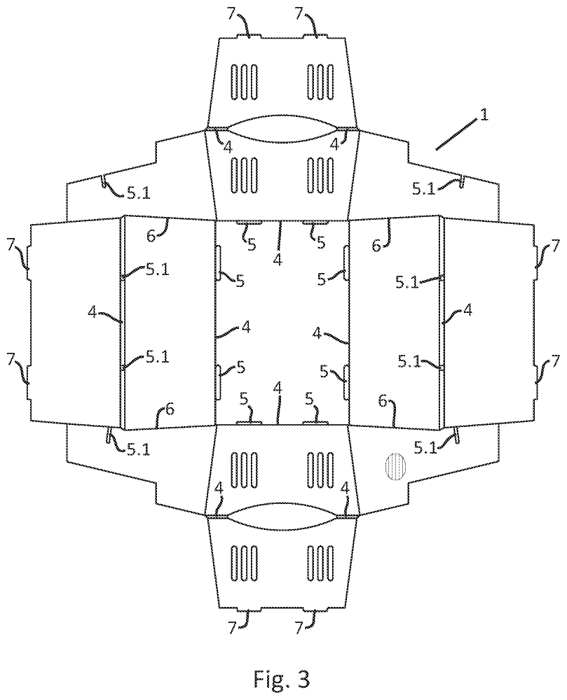

FIG. 3 is an external view of the technical plan of the basket (1) with internal dimensions 40×25×18 cm before assembly, showing its constructive details: lines/creases (4), cuts/slits (5 and 5.1), folds (6) and fittings (7) that give it the final shape and reinforce resistance.

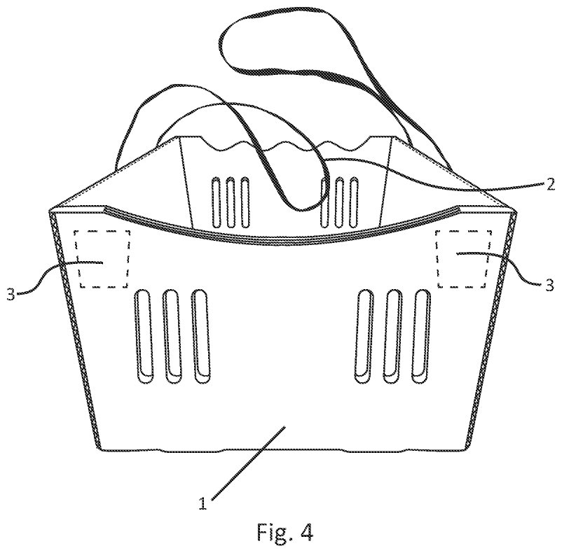

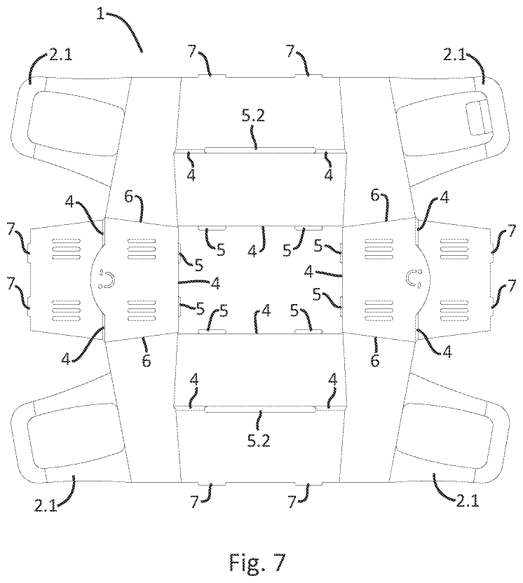

The handles (2 and 2.1) of the basket (1) are made of 5 mm kraft twisted cord (2), as can be seen in FIGS. 4, 5 and 6, or with the basket material itself (2.1), as can be seen in FIGS. 7, 8, 9, 10 and 11.

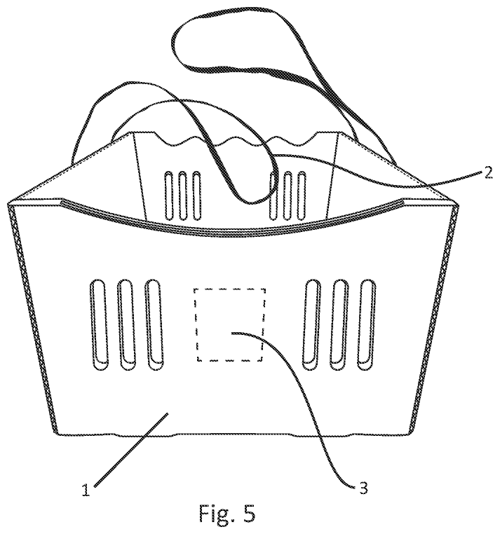

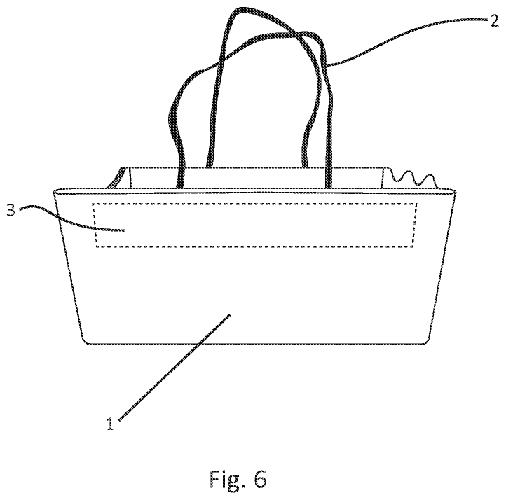

The basket (1) will have spaces (3) reserved for advertising products and brands. On the two smaller sides, which are on opposite sides, the upper left and right corners will be used, in addition to the central region, to highlight the attributes of the basket and the brand of the establishment, as highlighted in FIGS. 4 and 5. On both sides of larger dimensions, which are also on opposite sides, the upper and apparent field of the baskets, when stacked, will be reserved for the advertisement of brands and products, as highlighted in FIG. 6. Such formatting consists of a minimum standard for the disposition of information in order to guarantee the identity of the basket, but which may undergo changes to the convenience of the brand or establishment.

FIG. 7 is an external view of the technical plan of the basket (1) with internal dimensions 40×25×18 cm before assembly, showing its constructive details: handles (2.1) with the basket material itself (1), lines/creases (4), cuts/slits (5 and 5.2), folds (6) and fittings (7) that give it its final shape and reinforce its resistance.

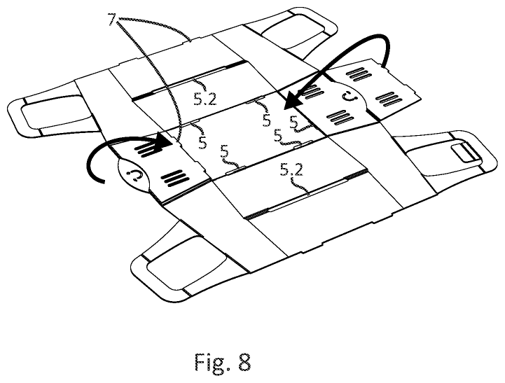

The assembly of the basket (1) must be started by flexing all the creases (4) and making the folds from the outside to the inside, then folding the upper faces until the fittings (7) fit perfectly in the slits (5) existing at the bottom of the basket (1), as can be seen in FIG. 8.

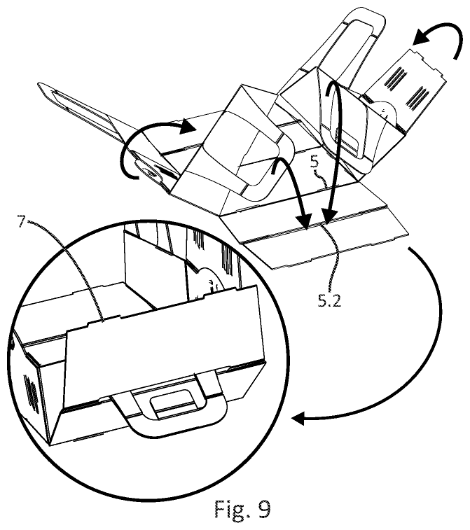

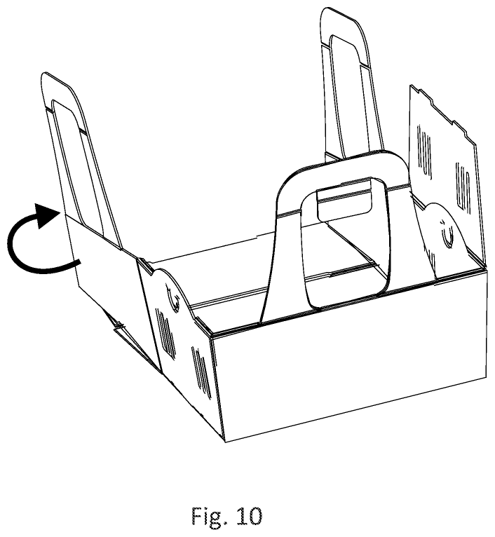

Then, fold the handles (2.1) into the basket (1), passing one at a time through the slit (5.2) in the central region of the largest face, keeping them aligned. Then, the larger faces are folded so that fittings (7) fit perfectly into the slits (5) on the bottom of the basket (1), as can be seen in FIG. 9. To assemble the other side of the basket (1), repeat the same process as in the previous step. The handles (2.1) are passed through the slit (5.2) positioned in the central region of the largest face, always bending them from the outside to the inside and, finally, fixing the fittings (7) in the slits (5) existing at the bottom of the box (1), as shown in FIG. 10.

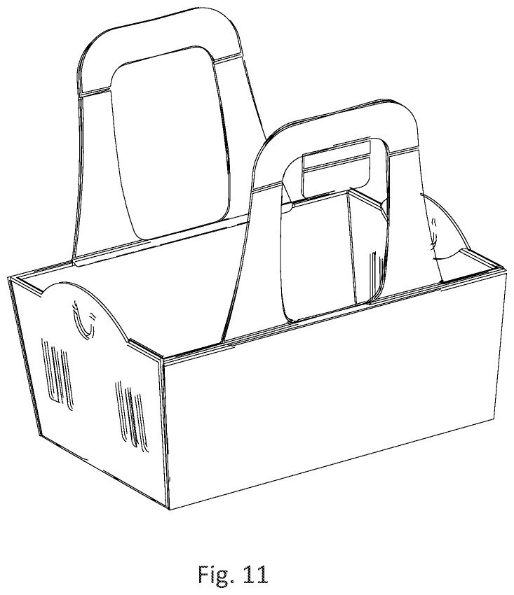

FIG. 11 is a perspective view of the basket (1) assembled with handles (2.1) made of its own material.

The present patent is based on the offer of an alternative to plastic (high density polyethylene), applied in the production of conventional shopping baskets or trays for carrying food or belongings, providing different sectors of the market with a product which is lighter, less aggressive to the environment and with a high potential for scale production, which replaces polluting materials with sustainable ones, resulting in functional improvement in its use, manufacture and disposal.

What is claimed is:

1. A basket of recycled material of cardboard or paperboard, formed by recycled material of cardboard or paperboard, with different layers and weight, the basket including handles, crease lines, slits, fold lines and fittings that give the basket a final shape and reinforce its strength, and with handles and spaces on external surfaces of the basket reserved for advertising products and brands.

2. The basket of recycled material of cardboard or paperboard, according to claim 1, wherein the basket is adapted to have different dimensions of length×width×height.

3. The basket of recycled material of cardboard or paperboard, according to claim 1, wherein the different dimensions of length×width×height include one of the following:
50×30×10 cm,
30×20×10 cm and
40×25×18 cm.

4. The basket of recycled material of cardboard or paperboard, according to claim 1, wherein the handles are formed by 5 mm kraft twisted cord.

5. The basket of recycled material of cardboard or paperboard, according to claim 1, wherein the handles are formed by the basket material of the basket itself
